(19) United States
(12) Patent Application Publication
(10) Pub. No.: US 2015/0296024 A1
(43) Pub. Date: Oct. 15, 2015

(54) Wireless Sensor Mesh Network with Dual-Homed Router and Control through Mobile Devices

(71) Applicants: Jordan Snyder, Black Hawk, CO (US); Jesse Snyder, Choctaw, OK (US); Pronoy Chopra, Norman, OK (US)

(72) Inventors: Jordan Snyder, Black Hawk, CO (US); Jesse Snyder, Choctaw, OK (US); Pronoy Chopra, Norman, OK (US)

(21) Appl. No.: 14/683,069

(22) Filed: Apr. 9, 2015

Related U.S. Application Data
(60) Provisional application No. 61/977,186, filed on Apr. 9, 2014.

(51) Int. Cl. H04L 29/08

(52) U.S. Cl. CPC H04L 67/125

(57) ABSTRACT

A wireless sensor mesh network for environmental monitoring utilizing a dual-homed router which may be completely controlled through a mobile device. A wireless system network that is modular and scalable allowing a user to easily integrate any custom combination that fits their needs. The first and most basic Sensors may be for temperature, humidity, CO2 levels in the air, soil moisture, and pH.

### RELATED APPLICATIONS

This utility patent application claims the benefit of U.S. Provisional Patent Application Ser. No. 61/977,186, filed on Apr. 9, 2014.

### BACKGROUND OF THE INVENTION

1. Field of the Invention

The present invention relates generally to wireless sensors. More particularly, the present invention pertains to a wireless sensor mesh network for environmental monitoring utilizing a dual-homed router which may be completely controlled through a mobile device.

2. Description of the Prior Art

Despite the many technological advances that have been made, such as genetically modified organisms and irrigation systems, weather still greatly affects agricultural productivity, Variations in local climate conditions, such as temperature changes, rainfall (timing and quantity), CO₂ levels and solar radiation can have a drastic effect on agricultural yield. Further, extreme weather events, such as droughts and floods, are forecast to increase based on the patterns of global climate change. Agriculture is a sector most vulnerable to the impact of climate change, and managing these events is a critical step in sustaining agricultural production, especially with the increased demand of output necessary to sustain the world's growing population.

It is very desirable to have an environmental monitoring system that allows growers to optimize agricultural productivity independent of ambient conditions. A critical feature of a successful greenhouse is the accurate measurement, reporting and control of greenhouse environmental conditions. Current solutions for environmental monitoring include relatively affordable “hobbyist” to moderately technical products from Custom Automated Products (C.A.P.) or Titan Controls as well as more expensive solutions custom-tailored for larger companies.

Low- to mid-range products from C.A.P. and Titan include devices that can sense temperature and activate a relay when a threshold is met, manage CO₂ concentration in a greenhouse/indoor growing environment, or manage timers for agricultural lighting, as well as many other similar products. However, the individual products do not communicate with each other forcing customers to buy multiple products to monitor the various conditions of their greenhouse or environmental space. Further, this separate control of the individual features does not assist with ensuring each condition is working harmoniously to create an optimal environment for growth and production. Additionally, current devices in the low to mid-price range are mostly analog and not digital, prohibiting the technology from reaching a level of sophistication consumers have come to expect in their devices.

Engineering fps or environmental monitoring firms tend to offer mid- to high-range products that include customizable systems for warehouse monitoring, HVAC monitoring, computer server monitoring and even fire control and safety monitoring. These systems are often very expensive and too complex for a grower, with say, one or two mid-sized greenhouses.

In light of the above, it is an object of the present invention to provide a reliable environmental monitoring system that offers the customizable, complex features of a high-end product in a device which is scalable and affordable.

### SUMMARY OF THE INVENTION

The present invention discloses a device referred to as “Sense” that is a wireless system for sensing and control of environmental conditions. Wireless sensors communicate with a wireless “Brain” which in turn communicates with the Internet and other devices.

Sense gathers information on environmental data, such as temperature and humidity, through a network of sensors which communicates with actuators that control the environment, for example, by turning on a fan or dehumidifier. A user may read and manipulate the environmental conditions through control panel software that may be accessed via computer or Smartphone from any remote location so long as there is internet or wifi access. Sense users may customize the control panel software to configure the sensors and actuators as desired to fit the user's needs.

The Sense system is comprised of waterproof, rugged sensor devices (“Sensors”) that can be placed apart in a mesh configuration where each Sensor can act as a pass-through for other sensors. As such, not every Sensor is required to communicate directly with the “Brain.”

The Sense system further includes a wireless router device, or “Coordinator,” that is able to communicate with the Sensors. The Coordinator uses a traditional Ethernet/802.11b wireless network for standard computer wireless communications. The Coordinator collects physical environmental data from the Sensors and stores the data locally on the Coordinator in an efficient, non-human readable format. The Coordinator can be viewed similar to a router, as it connects two different networks together.

The Sense system still further includes a mobile phone application for Android and iOS platforms. Through these applications users may access the data collected and stored on the Coordinator and view the data in the form of graphs and other such analytical views and tools. Depending on the network topology the mobile application may also connect to an external server that may also communicate with the Coordinator.

The Sense system still further includes a control component, or “Actuator”. The wireless Actuator is able to control other devices that may externally counteract undesirable environmental conditions to create an optimal environment for growth. Such devices include, for example, HVAC systems, exhaust fans, dehumidifiers and sprinklers. The Actuator may turn such devices on when specific environmental threshold levels are reached; such threshold levels may be programmed and customized by the user. The Actuator is controlled by the Coordinator through a website or mobile application. For example, if a user has a Sensor to control temperature, the user may specify a threshold temperature, of say 75 degrees, in the mobile application. If the environmental temperature exceeds 75 degrees, the Coordinator will instinct the Actuator to initiate a fan that is plugged into the Actuator circuit.

The Sense system may also include an option to store data in “the Cloud” enabling a user to remotely access data and wirelessly control the control system from anywhere in the world so long as there is internet or wifi access. When enabled, this option permits the Coordinator to send data over a secure and encrypted channel to “Cloud Sense” services. Users may log into the Cloud Sense services via the mobile application to view data from their monitoring system, set thresholds, run tests to check hardware, and the like. This feature allows the user to easily micro-manage and monitor the ecosystem.

It is a still further object of the invention to create a device that may be controlled wirelessly from a user's existing mobile device.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates an overview of the Sensor Device Hardware layout and Sensor Device Firmware layout as FIG. 1a and FIG. 1b, respectively.

FIG. 2 illustrates an overview of the Coordinator Hardware layout.

FIG. 3 illustrates an overview of the Actuator Device and Firmware layout.

FIG. 4 illustrates an overview of the communication link between the Sensor and Coordinator devices.

FIG. 5 illustrates an overview of the Coordinator software stack.

FIG. 6 illustrates an overview of the communication between the Coordinator and Mobile Application.

FIG. 7 illustrates an overview of the Sensor mobile application.

### DETAILED DESCRIPTION OF TIM INVENTION

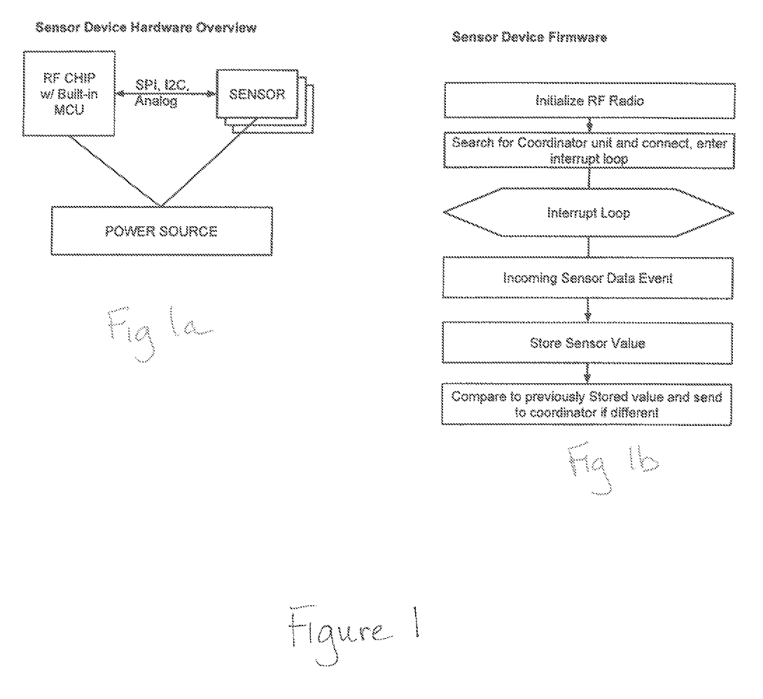

FIG. 1a depicts the Sensor Device Hardware 100 which consists of an RF microchip 100 (hereinafter “chip”) with embedded MCU (multiport control unit), known as the “Brain,” The Brain 101 coordinates communication between the sensors 102 and the RF portion of the chip 101. Ti a preferred embodiment, the chip is comprised of an ATmega128RFA1 chip having an AVR microcontroller and RF transceiver available from Amtel.

Various models of sensors 102 and interfacing options may be used in the Sense system. Types of sensors 102 applicable for agricultural use include, but are not limited to, air temperature, water temperature, air humidity, moisture, Carbon Dioxide or Monoxide, methane gas levels, photoelectric (light) levels, photosynthetically active radiation, liquid flow, air flow, barometric pressure, physical pressure, bend, and electrical conductivity. Further, the sensors 102 interface with Brain 101 using analog, SPI or I2C communications, which are common communication methods known in the art. Analog communication is the most raw and basic method of interfacing with electrical components. I2C is also a common method of interfacing, while SPI is a more advanced method supporting additional functionality.

The power source 103 for the Sense system consists of a small, mobile, rechargeable battery. In a preferred embodiment, the power source is comprised of a coin cell battery, though various battery types may be used depending on the recharge efficiency requirements of the particular system.

FIG. 1b depicts the functionality flow of Sensor Device Firmware 104 embedded on the Sensor Device Hardware 100 (shown in FIG. 1a). The firmware initializes the RF radio functions of the Brain 101, then searches for the Coordinator 105. Next the sensors 102 are initialized with appropriate configuration commands to wait for incoming data from the sensors 102. In the case where the sensors 102 interface over an analog signal, a polling mechanism may be used to poll analog voltage and process accordingly. Incoming sensor data is then compared to previously stored sensor data. If differences are found, that information is the sent over the RF connection to the Coordinator 105. By limiting transmission of data only to instances where there is differences in the incoming and stored data, the Sense device may generally remain in a low-power state until a difference is detected. Once a value difference is detected the Sense device will awaken to send such data to the Coordinator 105, then will return to its low-power state and continue to poll for value differences. Alternatively, when sensors interface using SPI or I2C, a signal enters an interrupter loop and sends the incoming sensor data to the Coordinator 105. The incoming data is compared to stored sensor data to determine if the two values are different.

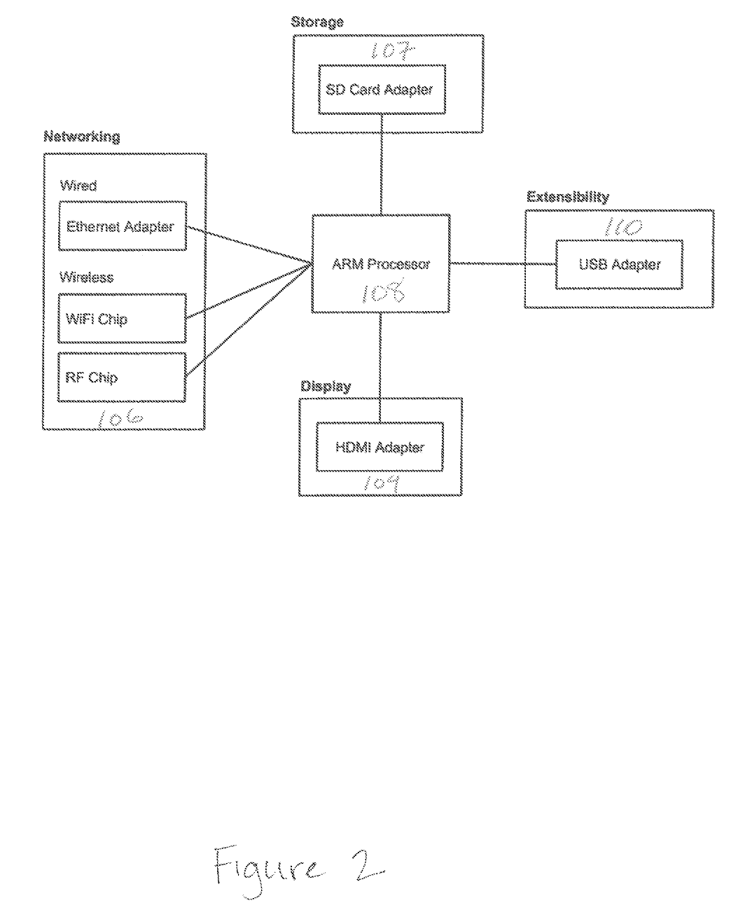

FIG. 2 depicts the Coordinator 105 hardware. The Coordinator 105 is comprised of a microprocessor 108 that is powerful enough to provide a wide range of functionality. In a preferred embodiment the microprocessor 108 may be a 1 GHz ARM Cortex A8 Microprocessor by Texas Instruments. The microprocessor 108 further includes a networking component 106, a storage component 107, a display port 109 and an extensibility port 110. The networking component 106 may be configured as a wired or wireless setup. In a wired embodiment, the networking port 106 connects to an ethernet adapter. Alternatively, in a wireless embodiment the networking port 106 may connect to a custom designed, built-in RF chip and wifi chip (“combo chip”), such as the Atmel ATMega128RFA1—the same chip used in the Sensor Hardware 100. This networking port 106 allows the Coordinator 105 to communicate with any number of Sensors 102 (not shown) over an ethernet network in a wired setup, or over a wifi network in a wireless setup. Further, the data stored within the Coordinator 105 may be available for the user to view via a display (not pictured) which may be connected through the display port 109 using an HDMI adapter. The display (not pictured) may consist of a television for visual alerts or an audio receiver for audio alerts. Still further, the microprocessor 108 is comprised of an extensibility unit 110, such as a USB adapter, allowing the Coordinator 105 to connect to other Coordinator devices for expanded capabilities or to external storage devices (not pictured) for data backup. Even still further, the microprocessor 108 is comprised of a storage component 107, such as an SD card adapter for configuration with an SD card. This allows the Coordinator 105 to store operating system installations, custom software and enables over-the-air (OTA) or manual software upgrades. Additionally the Coordinator 105 is capable of running Linux, Python, HTTP servers, and other such open source or commercial software, making the Coordinator 105 features customizable through programming.

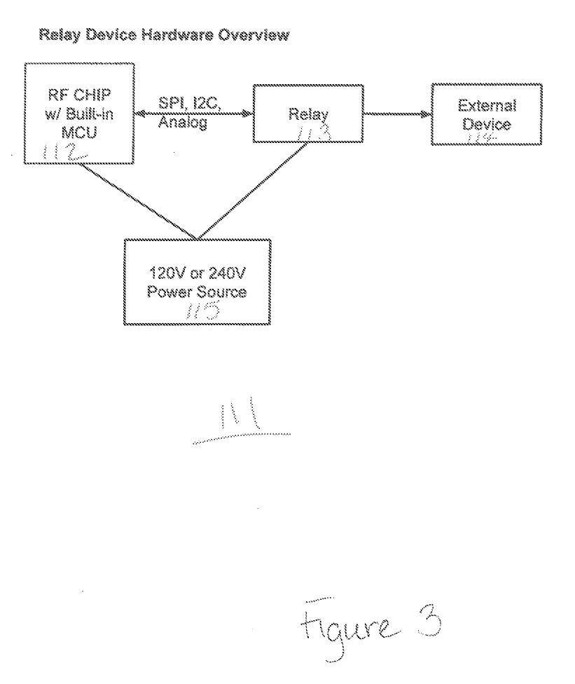

FIG. 3 depicts the actuator device 111 hardware. The actuator device 111 comprises an RF chip with a built-in MCU (hereinafter “chip”) 112 that communicates with a relay 113, both powered by a power source 115. Preferably, the chip may be the same Atmel ATMega 128RFA1 chip used in the Sensors 102 and Coordinator device 105. The chip 112 includes a wireless component allowing for wireless communication with the relay 113 along with an MCU for running firmware. The relay 113 consists of a solid state relay built for connection to devices drawing power at 15 A at 120 VAC or 240 VAC, though relays running at higher amperages may be used. The chip 112 and relay 113 may interface via an analog, SPI or I2C connection. In a preferred embodiment, an analog connection is used. Further, the power source 115 may comprise a 120V standard household source or a 240V commercial/industry power source. It is likely the 240V power source will be used for large-scale agricultural uses. Still further, the relay 113 connects to an external device 115 that the user connects in order to counteract undesirable environmental conditions to create an optimal environment for growth. Such devices 114 include, by way of example only, HVAC systems, exhaust fans, delumidifiers and sprinklers. The only requirement is that the external device 115 be configured with a 120V or 240V plug. By way of example, the actuator 111 initiates the external devices 114 when the chip applies, say, a 5V current to the relay 113, which then enables the power supply 115 to provide power to the external device 115 that the user specifically wants to power. The user may control such external devices 115 remotely via a mobile application accessible through a mobile phone, tablet or computer (not pictured). Moreover, such external devices 115 may be programmed to turn on and off based on timer settings, threshold values as evaluated according to sensor data, or manually by the user.

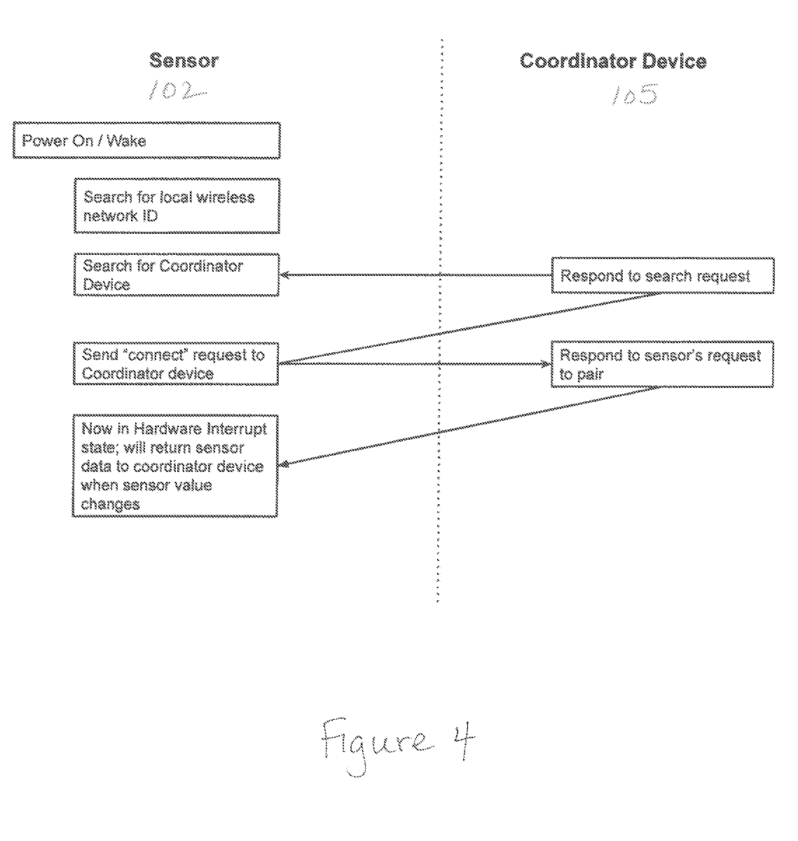

FIG. 4 describes communication between the sensor 102 and Coordinator 105. When the sensor 102 is powered on, it immediately searches for a Coordinator device 105 to connect with, if the Sensor 102 fails to immediately connect, it settles into a low-power state, at which point it searches for a Coordinator 105 at five minute intervals. When a sensor 102 successfully finds a connected Coordinator device 105, it will pair with that device 105; and will begin to submit sensor data at configurable intervals. By default the sensor 102 will transmit data only when the received sensor data values differ from the data values stored within the sensor 102. Additionally, the Coordinator device 105 can query the sensor 102 for specific details, such as sensor type or battery level.

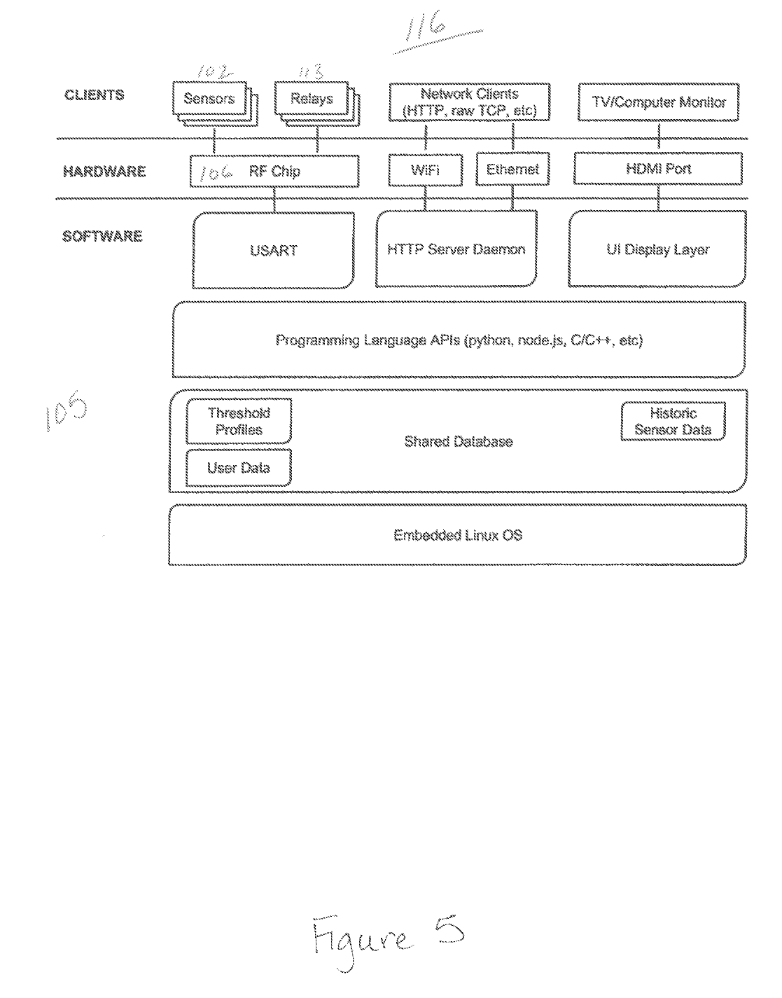

FIG. 5 describes the Coordinator software stack 116. The Coordinator device 105 may ran an embedded operating system, such as Linux, built for microprocessors. The operating system may include several components of custom software including web server code, database code, hardware interface code (serial communication to the RF chip), and display output and sound output code that runs when a user plugs in a display device 109 such as a television or stereo. The connection between the chip 106 and the main Linux system may be coded in Python. Further, the Coordinator device 105 may use a LISART link to communicate with the chip 106. Python code uses a serial library to accomplish such communication in a straightforward fashion. Further, Python code handles incoming data, detects new data, processes incoming messages to determine what message was sent, what sensor 102 or relay 113 sent the message and what specific data is available. In most cases, this will be incoming sensor data, and the Python code will write these values to the local. SQLite database in order to store this data. When new sensor data is committed to the database, separate Python code compares the new data to existing threshold data that is also stored in the local SQLite database. Based on the result of the comparison of new data to stored data, specific actions may be triggered depending on the user's configurations. As previously described, such actions may include initiation of external devices 114 connected to the actuator device 111, or even may include transmittal of data over the Internet in the form of a Facebook or Twitter posting, an SMS message, a phone call, or the like. In essence, users may develop the Linux platform to perform any series of configurable actions or to interface the Sense platform with countless other systems.

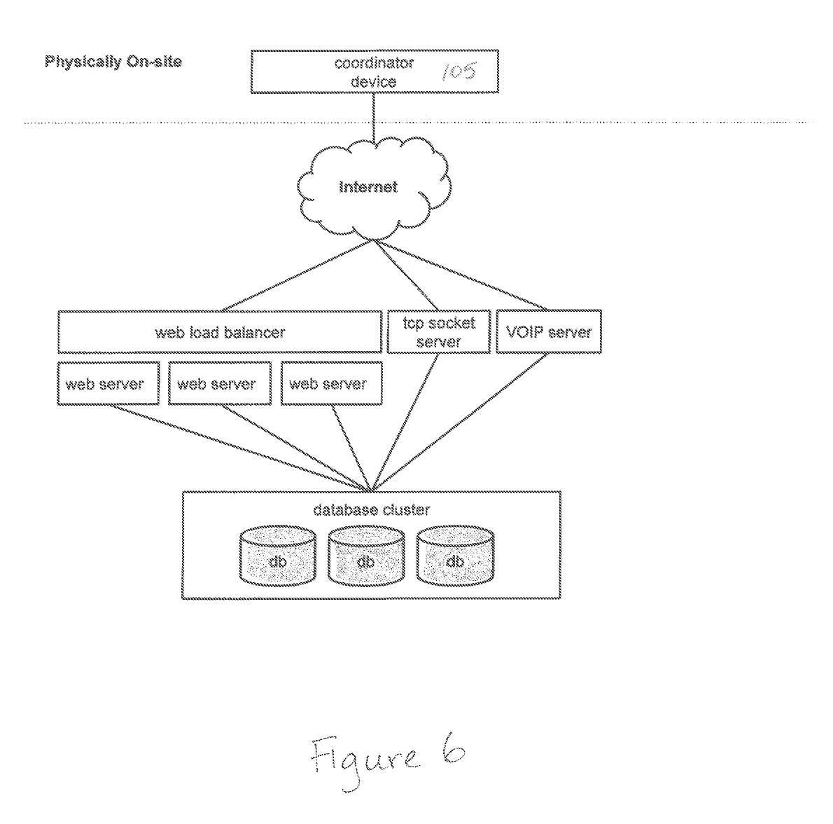

FIG. 6 provides an overview of how a user may remotely access data stored in the Cloud and also communicate with and manipulate the Sense system. Cloud data storage and communication is an optional feature that may be enabled for a user desiring to access sensor data while not physically on-site. A user may remotely log in through an internet or mobile application to access sensor data that has been synced with SenseCloud. Through this platform users may, for example, view sensor data and communicate with the Coordinator device 105 to change threshold levels, configure sensors 102 (not shown), update security and update software on the Coordinator device 105. Such communication and data storage within the Cloud is accomplished using web servers and connected databases accessible from any remote connection point so long as Internet access is available. Communication between the Coordinator device 105 and SenseCloud is configurable via short-polling (timer-based polling) or long-polling (server push). Server push is available where a server socket is kept open and connected to the Coordinator device 105 that is connected to the internet behind routers and firewalls. Moreover, SenseCloud will provide infrastructure and code over TCP servers and VOW servers.

Additionally, the Coordinator 105 device synchronizes with SenseCloud at configurable intervals depending on the complexity of the features the user wishes to enable. Intervals may defined in short periods, such as every five minutes, or longer intervals such as once a day. Further, SenseCloud syncing options may be shut off as desired where there are privacy concerns or where using the feature is no longer desired. Communication between the Sense system and the cloud may be encrypted with a minimum of a 128 bit SSL encryption. Stronger encryption options are available where the user has higher concerns with confidential data. The SenseCloud system may be run on a variety of platforms, such as Amazon's EC2 cloud service.

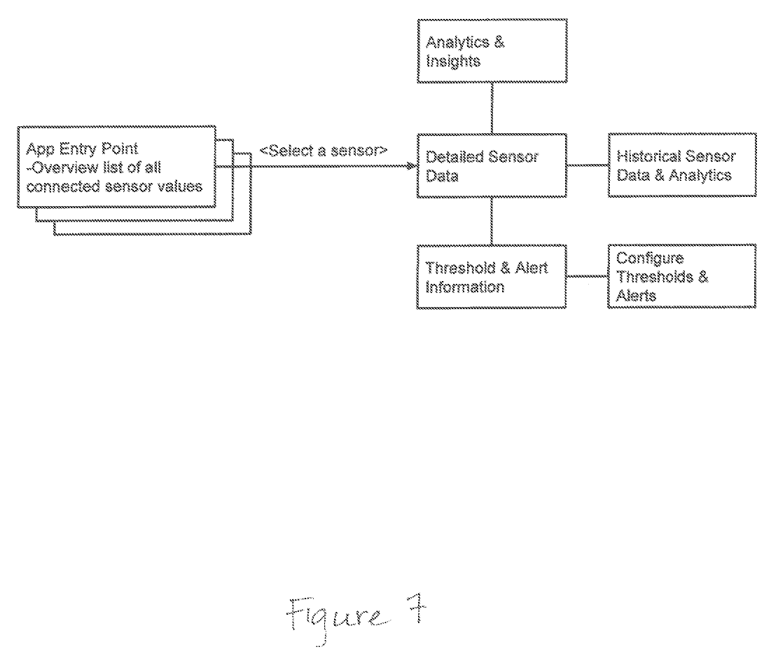

FIG. 7 describes the functionality of the Sense browser application and Sense mobile application. The Sense browser application and Sense mobile application are the primary means by which a user may interact with the sensor data, threshold values, configurations/settings, alerts, and all other Sense features configured in the Sense platform. The sensor data may be viewable and the Sense system may be configurable once the user securely logs into the application. After initial log in, a list of connected sensors 102 (not shown) and sensor data will appear. Sensor data may include basic information such as temperature, when the data was last updated, as well as any active thresholds, alerts, errors, warnings, or the like. The user may select a specific sensor 102 (not shown) to view further detailed information. Such information may be presented in the form of a line graph of historical sensor values that may be displayed according to specific criteria. Specific criteria may include a timeframe of anywhere from one day to two years. Viewing such analytics may provide a holistic view of environmental conditions over the course of seasons to understand observable trends and patterns. The application may also pull related data from various Internet sources allowing the user to compare external data to its own sensor data. This novel feature will make environmental control platforms much more useful and efficient.

In addition to viewing Sensor data, a user may interface with the Coordinator device 105 (not shown) to configure threshold values and alerts. For example, a user may set a threshold of 75 degrees Fahrenheit. Once this threshold is exceeded, a user may configure the Sense system to turn on an external device 114 (not shown) connected to the actuator device 111 (not shown), A command to accomplish this may be programmed as “Turn On Wireless Relay Device 2.” When the sensor 102 (not shown) reads the temperature as dipping back under the threshold value (+/− a configurable value, such as 3), the coordinator device 105 (not shown) will then command the actuator 111 (not shown) to turn the external device 114 (not shown) off. Along with the detailed data and insights that a user can gain from the detailed view, a user can also view Thresholds & Alerts and configure these Thresholds & Alerts.

### Practical Example

1. User receives a package of two temperature Sensors and one Coordinator unit.
2. User connects the Coordinator unit to a TV or computer monitor and sets it up on their WiFi network. Alternatively, User plugs in an Ethernet cable and logs in through the web interface or smartphone application.
3. Once User has set up the Coordinator unit's basic settings, the Coordinator will automatically detect the Sensors and communicate with them,
4. User sees Sensor visible in the Coordinator user interface (available via browser and smartphone applications) and can observe real-time values for that Sensor.
5. User is able see the type of Sensor (temperature, humidity, CO₂, etc.) and label it with, a customized name. The Sensor is identified by a unique ID, but the user provides a custom name to remember the Sensor (such as “Northeast Corner Temp”).
6. User sets “threshold” values for each Sensor. An example would be a threshold that is activated when a temperature sensor goes below 65 degrees.
7. For each threshold, custom actions are defined. Sense.io will provide wireless relays as output, for applications such as turning on exhaust fans. Other integrations will be easily configured for things like sending SAS messages, tweets, Facebook updates, and IFTTT (if this/then that) to open it up to endless possibilities for integration.

In one embodiment, the present invention provides a wireless sensor network for monitoring and controlling environmental conditions, the network comprised of:
a plurality of sensor components;
at least one wireless Coordinator component;
a mobile application;
a wireless actuator; and
a plurality of relay devices.

In another embodiment the Wireless sensor network for monitoring and controlling environmental conditions is further comprised of a Cloud computing component.

In a further embodiment the sensors are of a type selected from the group consisting of air temperature, water temperature, air humidity, moisture, Carbon Dioxide or Monoxide, methane gas levels, photoelectric (light) levels, photosynthetically active radiation, liquid flow, air flow, barometric pressure, physical pressure, bend, pH and electrical conductivity, hi yet another embodiment the sensors are arrange in a mesh array throughout the chosen environment to be monitored and controlled such that the sensors may serve as an information pass-through between other sensors and the coordination component.

In still another embodiment the sensors are further comprised of a multipart control unit and rechargeable power source wherein the power source may be a 120V standard household source or a 240V commercial/industry source.

In a further still embodiment, the coordinator component is further comprised of an embedded operating system, a shared database, a programming language and a means for communicating with the sensors.

In yet another embodiment, the coordinator component connects the sensor network with at least a second network wherein the coordinator receives information signals from the sensors either directly or passed through other sensors.

In a yet a further embodiment, the coordinator component stores previously collected sensor data locally such that the local data is compared to the signal data received by the coordinator from the sensors.

In still another embodiment, the coordinator component receives signal data in analog form from a polling mechanism. In still another embodiment, the coordinator component receives signal data through an interrupt loop.

In another embodiment, the coordinator component instructs a wireless actuator to power up and initiate control at least one external device.

In a further still embodiment, the external device adjusts the environmental condition detected by the coordinator to have varied from the preset data threshold indicated by the locally stored data.

In yet another embodiment, the present data threshold may be set using a mobile application on a smart device.

In still another embodiment, the present invention may be used for small to medium-sized greenhouse and/or agricultural monitoring. Since the system is modular and scalable, a user may easily integrate any custom combination that fits their needs. The first and most basic Sensors may be for temperature, humidity, CO₂ levels in the air, soil moisture, and pH. With Sensors in place at various locations around the greenhouse, a grower may be able to visualize how the temperature changes over time for a particular point of the greenhouse, identifying “hot spots” or “cold spots” that need to be addressed and adjusted in order to maximize the yield and quality of crop growth.

In yet another embodiment, the present invention may control timers for lights or automatically turn on supplemental lighting once the natural light dims below a certain threshold value.

In still another embodiment, the present invention provides from the beginning grower to the most experienced gardener or farmer complete control over all aspects of the crop environment through the integrated system.

In a further embodiment, the present invention provides a method of monitoring and controlling environmental conditions, the method comprised of using a wireless sensor network wherein the network is comprised of:
a plurality of sensor components;
at least one wireless Coordinator component;
a mobile application;
a wireless actuator; and
a plurality of relay devices.

It will be appreciated that details of the foregoing embodiments, even for purposes of illustration, are not to be construed as limiting the scope of the invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is farther defined in the converted utility application and appended claims. Further, it is recognized that many embodiments may be conceived that do not achieve all the advantages of some embodiments, particularly preferred embodiments, yet the absence of a particular advantage shall not be construed to necessarily mean that such an embodiment is outside the scope of the present invention.

We claim:

1. A wireless sensor network for monitoring and controlling environmental conditions, the network comprised of:
a plurality of sensor components;
at least one wireless Coordinator component;
a mobile application;
a wireless actuator; and
a plurality of relay devices.

2. The wireless sensor network of claim 1 further comprised of a Cloud computing component.

3. The wireless sensor network of claim 1 wherein the plurality of sensor components are of a type selected from the group consisting of air temperature, water temperature, air humidity, moisture, Carbon Dioxide or Monoxide, methane gas levels, photoelectric (light) levels, photosynthetically active radiation, liquid flow, air flow, barometric pressure, physical pressure, bend, pH and electrical conductivity.

4. The wireless sensor network of claim 1 wherein the sensors are arranged in a mesh array throughout the chosen environment to be monitored and controlled such that the sensors may serve as an information pass-through between other sensors and the coordination component.

5. The wireless sensor network of claim 1 wherein the sensors are further comprised of a multiport control unit and rechargeable power source wherein the power source may be a 120V standard household source or a 240V commercial/industry source.

6. The wireless sensor network of claim 1 wherein the coordinator component is further comprised of an embedded operating system, a shared, database, a programming language and a means for communicating with the sensors.

7. The wireless sensor network of claim 1 wherein the coordinator component connects the sensor network with at least a second network wherein, the coordinator receives information signals from the sensors either directly or passed through other sensors.

8. The wireless sensor network of claim 1 wherein the coordinator component stores previously collected sensor data locally such that the local data is compared to the signal data received by the coordinator from the sensors.

9. The wireless sensor network of claim 1 wherein the coordinator component receives signal data in analog form from a polling mechanism.

10. The wireless sensor network of claim 1 wherein the coordinator component receives signal data through an interrupt loop.

11. The wireless sensor network of claim 1 wherein the coordinator component instructs a wireless actuator to power up and initiate control at least one external device.

12. The wireless sensor network of claim 1 wherein the external device adjusts the environmental condition detected by the coordinator to have varied from the preset data threshold indicated by the locally stored data.

13. The wireless sensor network of claim 12 wherein the present data threshold may be set using a mobile application on a smart device.

14. The wireless sensor network of claim 13 wherein deviation from the threshold data results in the transmission of an alert or warning to a smart device.

15. The wireless sensor network of claim 8 wherein the plurality of relay devices are activated by the recording of a deviation of the present data as compared to the preset threshold.

16. The wireless sensor network of claim 15 wherein the activation of the plurality of relay devices results in the triggering of the devices to regulate the environmental condition for which a deviation from the threshold was detected.

17. A method of monitoring and controlling environmental conditions, the method comprised of using a wireless sensor network wherein the network is comprised of:
a plurality of sensor components;
at least one wireless Coordinator component;
a mobile application;
a wireless actuator; and
a plurality of relay devices.
